(19) United States
(12) Patent Application Publication
(10) Pub. No.: US 2011/0142802 A1
(43) Pub. Date: Jun. 16, 2011

(54) FUNGICIDAL COMPOSITIONS

(75) Inventors: Jeremy R. Godwin, Stein (CH); Stephan Trah, Stein (CH); Clemens Lamberth, Stein (CH); Raphael Dumeunier, Stein (CH); Valeria Grasso, Stein (CH); Sebastian Volker Wendeborn, Stein (CH)

(73) Assignee: SYNGENTA CROP PROTECTION, INC., Greensboro, NC (US)

(21) Appl. No.: 12/863,372

(22) PCT Filed: Jan. 14, 2009
(86) PCT No.: PCT/EP2009/000165

§ 371 Date: Feb. 28, 2011

(30) Foreign Application Priority Data
Jan. 16, 2008 (GB) 0800760.1

(51) Int. Cl. A01N 63/04; A01N 59/26; A01N 59/20; A01N 59/18; A01N 59/16; A01N 59/00; A01N 65/26; A01N 65/08; A01N 43/16; A01N 57/20; A01N 37/18; A01N 43/62; A01N 43/88; A01N 43/58; A01N 43/90; A01P 3/00

(52) U.S. Cl. 424/93.5; 424/605; 424/633; 424/635; 424/645; 424/654; 424/717; 424/761; 424/770; 514/37; 514/114; 514/154; 514/221; 514/229.2; 514/252.03; 514/259.31

(57) ABSTRACT

A fungicidal composition suitable for control of disease caused by phytopathogens comprising (A) a compound of formula (I), wherein R¹ is methyl, ethyl or isopropyl; R² is 2-chloro-6-fluoro-phenyl, 2,4,6-trifluorophenyl or 2,6-difluoro-4-methoxy-phenyl; R³ is chloro, fluoro or methoxy; and (B) a compound selected, for example, from the group consisting of (B1) a strobilurin fungicide, (B2) an azole fungicide, (B3) a morpholine fungicide, and (B4) an anilinopyrimidine fungicide.

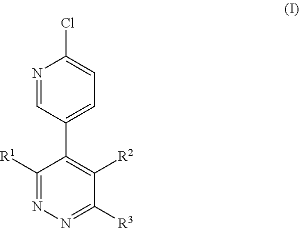

The present invention relates to novel fungicidal compositions suitable for control of diseases caused by phytopathogens, especially phytopathogenic fungi and to a method of controlling diseases on useful plants.

It is known from WO 2005/121104, WO 2006/001175, WO 2007/066601 and WO 2007/080720 that certain pyridazine derivatives have biological activity against phytopathogenic fungi. On the other hand various fungicidal compounds of different chemical classes are widely known as plant fungicides for application in various crops of cultivated plants. However, not all fungicides have the full range of necessary strengths for a commercial product to fully meets the farmers' needs, e.g. incomplete spectrum of diseases controlled or level of activity insufficient for good control of all key diseases, inability to fully control diseases if applied after infection has occurred or loss of activity against certain strains of plant pathogenic fungi which have developed resistance to the fungicide in question.

Out of the above-mentioned needs of agricultural practice, there is therefore proposed in accordance with the present invention a novel fungicidal composition suitable for control of diseases caused by phytopathogens comprising:

(A) a compound of formula I

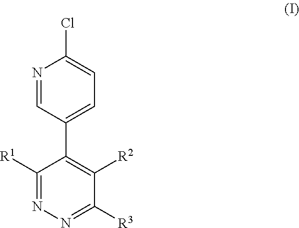

wherein

R¹ is methyl, ethyl or isopropyl;

R² is 2-chloro-6-fluoro-phenyl, 2,4,6-trifluorophenyl or 2,6-difluoro-4-methoxy-phenyl;

R³ is chloro, fluoro or methoxy; and

(B) a compound selected from the group consisting of
(B1) a strobilurin fungicide,
(B2) an azole fungicide,
(B3) a morpholine fungicide,
(B4) an anilinopyrimidine fungicide,
(B5) a fungicide selected from the group consisting of
anilazine (878), arsenates, benalaxyl (56), benalaxyl-M, benodanil (896), benomyl (62), benthiavalicarb, benthiavalicarb-isopropyl (68), biphenyl (81), bitertanol (84), blasticidin-S (85), bordeaux mixture (87), boscalid (88), bupirimate (98), cadmium chloride, captafol (113), captan (114), carbendazim (116), carbon disulfide (945), carboxin (120), carpropamid (122), cedar leaf oil, chinomethionat (126), chlorine, chloroneb (139), chlorothalonil (142), chlozolinate (149), cinnamaldehyde, copper, copper ammoniumcarbonate, copper hydroxide (169), copper octanoate (170), copper oleate, copper sulphate (87), cyazofamid (185), cycloheximide (1022), cymoxanil (200), dichlofluanid (230), dichlone (1052), dichloropropene (233), diclocymet (237), diclomezine (239), dicloran (240), diethofencarb (245), diflumetorim (253), dimethirimol (1082), dimethomorph (263), dinocap (270), dithianon (279), dodine (289), edifenphos (290), ethaboxam (304), ethirimol (1133), etridiazole (321), famoxadone (322), fenamidone (325), fenaminosulf (1144), fenamiphos (326), fenarimol (327), fenfuram (333), fenhexamid (334), fenoxanil (338), fenpiclonil (341), fentin acetate (347), fentin chloride, fentin hydroxide (347), ferbam (350), ferimzone (351), fluazinam (363), fludioxonil (368), flusulfamide (394), flutolanil (396), folpet (400), formaldehyde (404), fosetyl-aluminium (407), fthalide (643), fuberidazole (419), furalaxyl (410), furametpyr (411), flyodin (1205), fuazatine (422), hexachlorobenzene (434), hymexazole, iminoctadine (459), iodocarb (3-Iodo-2-propynyl butyl carbamate), iprobenfos (IBP) (469), iprodione (470), iprovalicarb (471), isoprothiolane (474), kasugamycin (483), mancozeb (496), maneb (497), manganous dimethyldithiocarbamate, mefenoxam (Metalaxyl-M) (517), mepronil (510), mercuric chloride (511), mercury, metalaxyl (516), methasulfocarb (528), metiram (546), metrafenone, nabam (566), neem oil (hydrophobic extract), nuarimol (587), octhilinone (590), ofurace (592), oxadixyl (601), oxine copper (605), oxolinic acid (606), oxycarboxin (608), oxytetracycline (611), paclobutrazole (612), paraffin oil (628), paraformaldehyde, pencycuron (620), pentachloronitrobenzene (716), pentachlorophenol (623), penthiopyrad, perfurazoate, phosphoric acid, polyoxin (654), polyoxin D zinc salt (654), potassium bicarbonate, probenazole (658), procymidone (660), propamocarb (668), propineb (676), proquinazid (682), prothiocarb (1361), pyrazophos (693), pyrifenox (703), pyroquilon (710), quinoxyfen (715), quintozene (PCNB) (716), silthiofam (729), sodium bicarbonate, sodium diacetate, sodium propionate, streptomycin (744), sulphur (754), TCMTB, tecloftalam, tecnazene (TCNB) (767), thiabendazole (790), thifluzamide (796), thiophanate (1435), thiophanate-methyl (802), thiram (804), tolclofos-methyl (808), tolylfluanid (810), triazoxide (821), trichoderma harzianum (825), tricyclazole (828), triforine (838), triphenyltin hydroxide (347), validamycin (846), vinclozolin (849), zineb (855), ziram (856), zoxamide (857), 1,1-bis(4-chlorophenyl)-2-ethoxyethanol (IUPAC-Name) (910), 2,4-dichlorophenyl benzenesulfonate (IUPAC-/Chemical Abstracts-Name) (1059), 2-fluoro-N-methyl-N-1-naphthylacetamide (IUPAC-Name) (1295), 4-chlorophenyl phenyl sulfone (IUPAC-Name) (981),
a compound of formula B-5.1

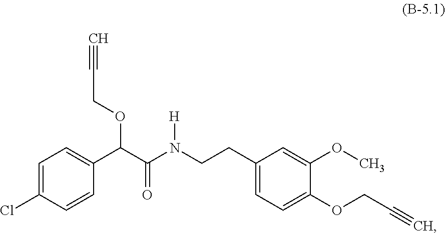

a compound of formula B-5.2

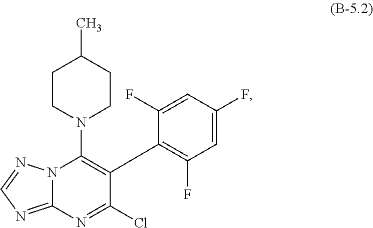

a compound of formula B-5.3

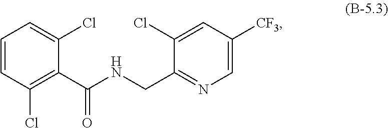

a compound of formula B-5.4

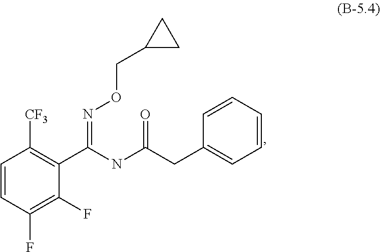

a compound of formula B-5.5

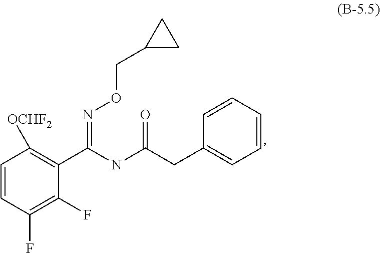

a compound of formula B-5.6

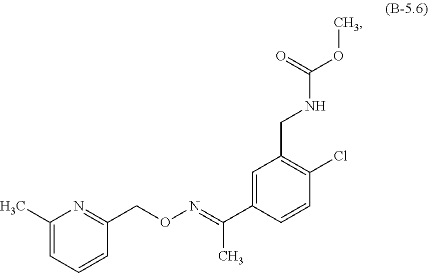

a compound of formula B-5.7

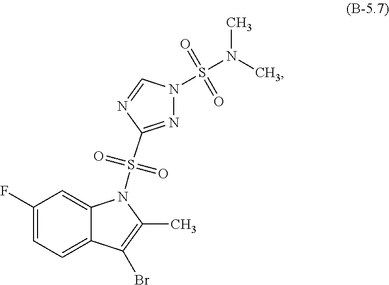

3-difluoromethyl-1-methyl-1H-pyrazole-4-carboxylic acid (2-bicyclopropyl-2-yl-phenyl)-amide (compound B-5.8), 3-difluoromethyl-1-methyl-1H-pyrazole-4-carboxylic acid (9-isopropyp-1,2,3,4-tetrahydro-1,4-methano-naphthalen-5-yl)-amide (compound B-5.9), 1,3-dimethyl-5-fluoro-1H-pyrazole-4-carboxylic acid [2-(1,3-dimethylbutyl)phenyl]-amide (compound B-5.10), 3-difluoromethyl-1-methyl-1H-pyrazole-4-carboxylic acid (3′,4′-dichloro-5-fluoro-1,1′-biphenyl-2-yl)-amide (compound B-5.11), N-{2-[3-chloro-5-(trifluoromethyl)pyridin-2-yl]ethyl}-2-(trifluoromethyl)benzamid (compound B-5.12), 3-difluoromethyl-1-methyl-1H-pyrazole-4-carboxylic acid N-[2-(1,1,2,2-tetrafluoroethoxy)phenyl]-amide (compound B-5.13), 3-difluoromethyl-1-methyl-1H-pyrazole-4-carboxylic acid N-[2-(1,1,2,3,3,3-hexafluoropropoxy)phenyl]-amide (compound B-5.14), 3-difluoromethyl-1-methyl-1H-pyrazole-4-carboxylic acid N-[2-(2-chloro-1,1,2-trifluoroethoxy)phenyl]-amide (compound B-5.15), 3-difluoromethyl-1-methyl-1H-pyrazole-4-carboxylic acid N-(4′-trifluoromethyl-biphen-2-yl)-amide (compound B-5.16), 3-difluoromethyl-1-methyl-1H-pyrazole-4-carboxylic acid N-(2′-trifluoromethyl-biphen-2-yl)-amide (compound B-5.17), 3-difluoromethyl-1-methyl-1H-pyrazole-4-carboxylic acid N-(2′-trifluoromethyl-biphen-2-yl)-amide (compound B-5.18),
a compound of formula B-5.19

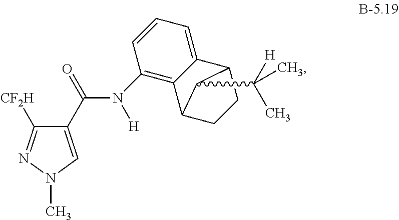

a compound of formula B-5.20

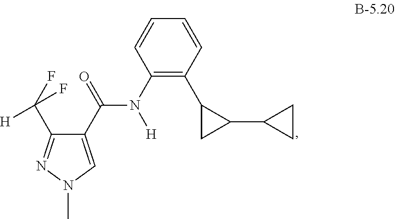

(B6) a plant-bioregulator selected from the group consisting of
acibenzolar-5-methyl (6), chlormequat chloride (137), ethephon (307), mepiquat chloride (509) and trinexapac-ethyl (841);
(B7) an insecticide selected from the group consisting of
abamectin (1), clothianidin (165), emamectin benzoate (291), imidacloprid (458), tefluthrin (769), thiamethoxam (792), lambda cyhalothrin (198), a compound of formula B-7.1

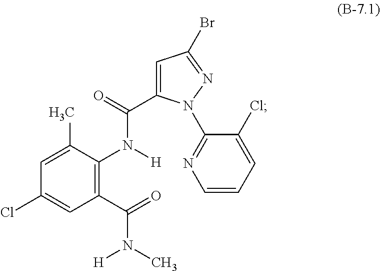

and a compound of formula B-7.2;

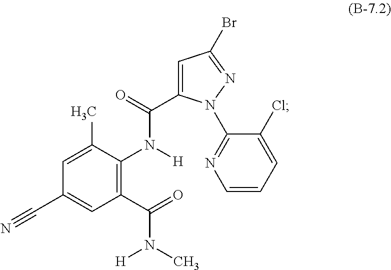

and
(B8) glyphosate (419), clodinafop propargyl (156) or pinoxaden (668).

The use of component (B) in combination with component (A) surprisingly and substantially enhance the effectiveness of the latter against fungi, and vice versa. Additionally, the method of the invention is effective against a wider spectrum of such fungi that can be combated with the active ingredients of this method, when used solely.

The presence of one or more possible asymmetric carbon atoms in a compound of formula I means that the compounds may occur in optically isomeric, that means enantiomeric or diastereomeric forms. As a result of the presence of a possible aliphatic C═C double bond, geometric isomerism, that means cis-trans or (E)-(Z) isomerism may also occur. Also atropisomers may occur as a result of restricted rotation about a single bond. Formula I is intended to include all those possible isomeric forms and mixtures thereof. The present invention intends to include all those possible isomeric forms and mixtures thereof for a compound of formula I.

In each case, the compounds of formula I according to the invention are in free form or in an agronomically usable salt form.

A first embodiment of the invention is represented by those compositions which comprise as component A) a compound of formula (I),

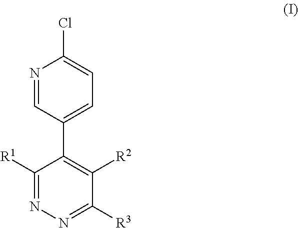

wherein R¹ is methyl; R² is 2,4,6-trifluorophenyl; and R³ is chloro; i.e. 3-chloro-5-(6-chloro-pyridin-3yl)-6-methyl-4-(2,4,6-trifluoro-phenyl)-pyridazine (compound A-1.1).

A second embodiment of the invention is represented by those compositions which comprise as component A) a compound of formula (I),

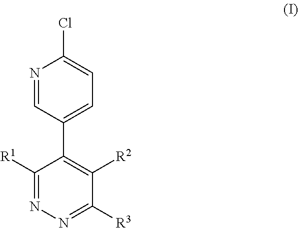

wherein R¹ is methyl; R² is 2-chloro-6-fluoro-phenyl; and R³ is chloro; i.e. 3-chloro-5-(6-chloro-pyridin-3-yl)-6-methyl-4-(2-chloro-6-fluoro-phenyl)-pyridazine (compound A-1.2).

A third embodiment of the invention is represented by those compositions which comprise as component A) a compound of formula (I),

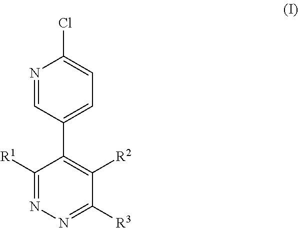

wherein R¹ is methyl; R² is 2,4,6-trifluorophenyl; and R³ is methoxy; i.e. 4-(6-chloro-pyridin-3-yl)-6-methoxy-3-methyl-5-(2,4,6-trifluoro-phenyl)-pyridazine (compound A-1.3).

Most preferred embodiment of the invention is represented by those compositions which comprise as component A) a compound of formula (I), wherein R¹ is methyl; R² is 2,4,6-trifluorophenyl; and R³ is chloro; i.e. 3-chloro-5-(6-chloro-pyridin-3yl)-6-methyl-4-(2,4,6-trifluoro-phenyl)-pyridazine (compound A-1.1).

Certain pyridazine derivatives with aryl or heteroaryl groups in positions 4 and 5 have been proposed for controlling plant-destructive fungi, for example in WO 2005/121104, WO 2006/001175, WO 2007/066601 and WO 2007/080720. However, the action of those preparations is not satisfactory in all aspects of agricultural needs. Surprisingly, with the compounds of formula I, new kinds of fungicides having a high level of biological activity have now been found.

Compounds of formula (I.1), (I.2), (I.3) and (I.5), in which R¹, R², R³, R⁵ and R⁶ have the meanings given above, are all examples of compounds of general formula (I) and can be made as shown in the following schemes.

The compounds of formula I.2, wherein R¹, R² and R³ are as defined for formula I, can be obtained by transformation of a compound of formula I.1, wherein R¹, R² and R³ are as defined for formula I, with methanol and base or with sodium methoxide.

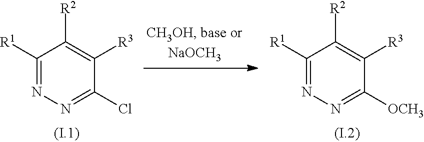

The compounds of formula I.1, wherein R¹, R² and R³ are as defined for formula I, can be obtained by transformation of a compound of formula I.3, wherein R¹, R² and R³ are as defined for formula I, with phosphorus oxychloride or thionyl chloride.

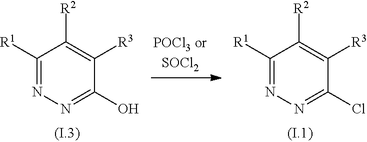

The compounds of formula I.3, wherein R¹, R² and R³ are as defined for formula I, can be obtained by transformation of a compound of formula II, wherein R¹, R² and R³ are as defined for formula I, with a hydrazine derivative, e.g. hydrazine hydrate.

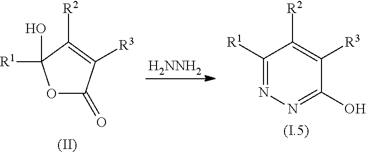

The compounds of formula II, wherein R¹, R² and R³ are as defined for formula I, can be obtained by transformation of a compound of formula III, wherein R¹, R² and R³ are as defined for formula I, by oxidation with oxygen, air or 3-chloroperbenzoic acid.

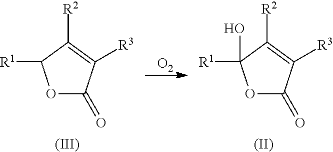

The compounds of formula III, wherein R¹, R² and R³ are as defined for formula I, can be obtained by transformation of a compound of formula IV, wherein R¹, R² and R³ are as defined for formula I, with a base, e.g. pyridine, triethylamine, diisopropylethylamine, 1,5-diazabicyclo[4.3.0]non-5-ene or 1,8-diazabicyclo[5.4.0]undec-7-ene.

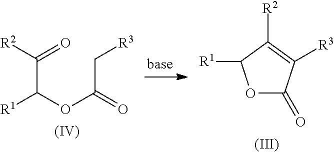

The compounds of formula IV, wherein R¹, R² and R³ are as defined for formula I, can be obtained by transformation of a compound of formula V, wherein R¹ and R² are as defined for formula I and Hal is halogen, preferably chlorine or bromine, with a compound of formula VI, wherein R³ is as defined for formula I, and a base, e.g. pyridine, triethylamine, diisopropylethylamine, 1,5-diazabicyclo[4.3.0]non-5-ene or 1,8-diazabicyclo[5.4.0]undec-7-ene.

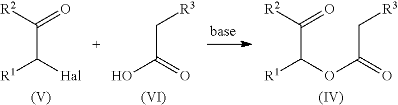

Surprisingly, it has now been found that the novel compounds of formula I have, for practical purposes, a very advantageous level of biological activity for protecting plants against diseases that are caused by fungi as well as by bacteria and viruses.

The compounds of formula I can be used in unmodified form or, preferably, together with carriers and adjuvants conventionally employed in the art of formulation.

In another aspect, the present invention relates to a method of controlling diseases on useful plants or on propagation material thereof caused by phytopathogens, which comprises applying to the useful plants, the locus thereof or propagation material thereof a composition according to the invention comprising

(A) a compound of formula I

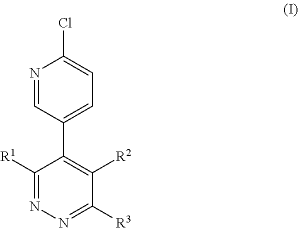

wherein

R¹ is methyl, ethyl or isopropyl;

R² is 2-chloro-6-fluoro-phenyl, 2,4,6-trifluorophenyl or 2,6-difluoro-4-methoxy-phenyl;

R³ is chloro, fluoro or methoxy; and

(B) a compound selected from the group consisting of (B1), (B2), (B3), (B4), (B5), (B6), (B7) and (B8) as previously defined.

In a first embodiment, the present invention relates to a method, wherein the disease is a species of Alternaria spp. and the useful plants are potato or tomato.

In a second embodiment, the present invention relates to a method wherein the disease is a species of Mycosphaerella spp. and the useful plants are wheat or groundnut, e.g. peanut.

In a third embodiment, the present invention relates to a method wherein the disease is a species of Pyrenophora spp. and the useful plant is barley.

In a further aspect, the present invention relates to a method of controlling diseases, which have developed resistance to a number of existing fungicide modes of action, on useful plants or on propagation material thereof caused by phytopathogens, that comprises applying to the useful plants, the locus thereof or propagation material thereof a composition according to the invention comprising

(A) a compound of formula I

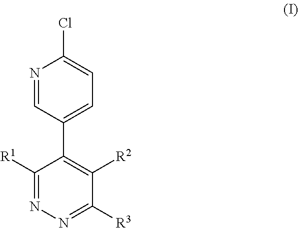

wherein

R¹ is methyl, ethyl or isopropyl;

R² is 2-chloro-6-fluoro-phenyl, 2,4,6-trifluorophenyl or 2,6-difluoro-4-methoxy-phenyl;

R³ is chloro, fluoro or methoxy; and

(B) a compound selected from the group consisting of (B1), (B2), (B3), (B4), (B5), (B6), (B7) and (B8) as previously defined. Preferred is a method, which comprises applying to the useful plants or to the locus thereof a composition according to the invention, more preferably to the useful plants. Further preferred is a method, which comprises applying to the propagation material of the useful plants a composition according to the invention.

Compounds of formula (I) may be obtained as described in examples 1, which are non-limiting examples illustrating the above described invention in more detail.

### EXAMPLE 1

### This example illustrates the preparation of 3-chloro-5-(6-chloro-pyridin-3-yl)-6-methyl-4-(2,4,6-trifluorophenyl)-pyridazine (compound A-1.1)

### a) Preparation of 2-bromo-1-(6-chloro-pyridin-3-yl)-propan-1-one

Bromine (45.4 g) is slowly added to the mixture of 1-(6-chloro-pyridin-3-yl)-propan-1-one (48.2 g), 0.4 ml of hydrobromic acid (33% solution in acetic acid) and 250 ml of acetic acid at room temperature under a nitrogen atmosphere. Subsequently, the mixture is slowly heated to 80° C. The reaction mixture is stirred at 80° C. for 30 min, during which a yellow suspension is formed, then cooled down to 10° C. and filtered. The solid remainder is washed with tert-butyl methyl ether to deliver 2-bromo-1-(6-chloro-pyridin-3-yl)-propan-1-one hydrobromide as a yellowish solid. To a suspension of this intermediate in 800 ml of tert-butyl methyl ether is added 400 ml of a saturated aqueous sodium bicarbonate solution and the reaction mixture is stirred for 15 min. The phases are separated, the organic layer is washed with brine, dried over sodium sulfate and concentrated under reduced pressure to obtain 2-bromo-1-(6-chloro-pyridin-3-yl)-propan-1-one as an oil.

### b) Preparation of 4-(6-chloro-pyridin-3-yl)-5-hydroxy-5-methyl-3-(2,4,6-trifluorophenyl)-5H-furan-2-one

Triethylamine (25.2 g) is slowly added to a solution of 2-bromo-1-(6-chloro-pyridin-3-yl)-propan-1-one (61.3 g), 2,4,6-trifluorophenylacetic acid (47.3 g) in 500 ml of acetonitrile and this mixture is stirred for 16 h at room temperature. Subsequently 1,8-diazabicyclo[5.4.0]undec-7-ene (DBU, 82.7 g) is slowly added under cooling and stirring is continued for further 2 h. Then air is blown through the reaction mixture for 3 h. The reaction mixture is poured into an aqueous ammonium chloride solution and the mixture is extracted with ethyl acetate. The combined organic layer is washed with brine, dried over sodium sulfate and evaporated under reduced pressure. The remainder is purified by chromatography on silica gel, using a mixture of heptane/ethyl acetate 2:1 as eluent to obtain 4-(6-chloro-pyridin-3-yl)-5-hydroxy-5-methyl-3-(2,4,6-trifluorophenyl)-5H-furan-2-one as yellowish foam.

### c) Preparation of 5-(6-chloro-pyridin-3-yl)-6-methyl-4-(2,4,6-trifluorophenyl)-2H-pyridazin-3-one (Compound No. I.a.10)

Hydrazine hydrate (10 g) is added to a solution of 4-(6-chloro-pyridin-3-yl)-5-hydroxy-5-methyl-3-(2,4,6-trifluorophenyl)-5H-furan-2-one (Compound No. II.a.4, 69 g) in 350 ml of 1-butanol and this mixture is heated for 7 h to 120° C. Subsequently, the mixture is poured into 400 ml of tert-butyl methyl ether. The resulting mixture is stirred for 30 min, then cooled to 0° C. and filtered. The solid remainder is washed with tert-butyl methyl ether to deliver 5-(6-chloro-pyridin-3-yl)-6-methyl-4-(2,4,6-trifluorophenyl)-2H-pyridazin-3-one as light brown solid.

d) A mixture of 5-(6-chloro-pyridin-3-yl)-6-methyl-4-(2,4,6-trifluorophenyl)-2H-pyridazin-3-one (45.1 g) and 160 ml of phosphorus oxychloride is heated at 110° C. for 1 h. After cooling the reaction mixture is evaporated under reduced pressure. The remainder is taken up with ethyl acetate and water and the phases are separated. The organic layer is washed with water and brine, dried over sodium sulfate and evaporated under reduced pressure. The residue is recrystallised from toluene to deliver 3-chloro-5-(6-chloro-pyridin-3-yl)-6-methyl-4-(2,4,6-trifluorophenyl)-pyridazine (compound A-1.1) as colourless crystals, m.p. 182-183° C.

### EXAMPLE 2

### This example illustrates the preparation of 4-(6-chloro-pyridin-3-yl)-6-methoxy-3-methyl-5-(2,4,6-trifluoro-phenyl)-pyridazine (compound A-1.3)

A mixture of 3-chloro-5-(6-chloro-pyridin-3-yl)-6-methyl-4-(2,4,6-trifluorophenyl)-pyridazine (Compound A-1.1, 700 mg), sodium methoxide (30% solution in methanol, 750 mg) and 10 ml of methanol is heated for 6 h to 60° C. Subsequently the reaction mixture is cooled, diluted with water and extracted with ethyl acetate. The combined organic layer is washed with water and brine, dried over sodium sulfate and evaporated under reduced pressure. The remainder is purified by chromatography on silica gel, using a mixture of heptane/ethyl acetate 3:1 as eluent to obtain 4-(6-chloro-pyridin-3-yl)-6-methoxy-3-methyl-5-(2,4,6-trifluoro-phenyl)-pyridazine (Compound A-1.3), m.p. 123-124° C.

Table 1 shows the melting points for selected compounds of formula I (compounds A-1.1, A-1.2 and A-1.3). Temperatures are given in degrees Celsius.

TABLE 1
Melting point of compounds of form

| Compound Number | m.p. (° C.) |
|---|---|
| A-1.1 | 182-183 |
| A-1.2 | 166-167 |
| A-1.3 | 123-124 |

As described above, the novel fungicidal composition of the present invention is comprised of a selected compound of formula (I) that is combined with one or more compounds identified above as component (B) of this composition. The component (B) compounds are known in the art and some are, for example, identified in “The Pesticide Manual” [The Pesticide Manual—A World Compendium; Thirteenth Edition; Editor: C. D. S. Tomlin; The British Crop Protection Council], they are described therein under the entry number given in round brackets hereinabove for the particular component (B); for example, the compound “abamectin” is described under entry number (1). Most of the components (B) are referred to hereinabove by a so-called “common name”, the relevant “ISO common name” or another “common name” being used in individual cases. If the designation is not a “common name”, the nature of the designation used instead is given in round brackets for the particular component (B); in that case, the IUPAC name, the IUPAC/Chemical Abstracts name, a “chemical name”, a “traditional name”, a “compound name” or a “development code” is used or, if neither one of those designations nor a “common name” is used, an “alternative name” is employed.

The following components B) are registered under a CAS-Reg. No.:

aldimorph (CAS 91315-15-0); arsenates (CAS 1327-53-3); benalaxyl-M (CAS 98243-83-5); benthiavalicarb (CAS 413615-35-7); cadmium chloride (CAS 10108-64-2); cedar leaf oil (CAS 8007-20-3); chlorine (CAS 7782-50-5); cinnamaldehyde (CAS: 104-55-2); copper ammoniumcarbonate (CAS 33113-08-5); copper oleate (CAS 1120-44-1); iodocarb (3-Iodo-2-propynyl butyl carbamate) (CAS 55406-53-6); hymexazole (CAS 10004-44-1); manganous dimethyldithiocarbamate (CAS 15339-36-3); mercury (CAS 7487-94-7; 21908-53-2; 7546-30-7); metrafenone (CAS 220899-03-6); neem oil (hydrophobic extract) (CAS 8002-65-1); orysastrobin (CAS 248593-16-0); paraformaldehyde (CAS 30525-89-4); penthiopyrad (CAS 183675-82-3); phosphoric acid (CAS 7664-38-2); potassium bicarbonate (CAS 298-14-6); sodium bicarbonate (CAS 144-55-8); sodium diacetate (CAS 127-09-3); sodium propionate (CAS 137-40-6); TCMTB (CAS 21564-17-0); and tolyfluanid (CAS 731-27-1).

Compound B-1.1 (“enestrobin”) is described in EP-O-936-213; compound B-3.1 (“flumorph”) in U.S. Pat. No. 6,020,332, CN-1-167-568, CN-1-155-977 and in EP-O-860-438; compound B-5.1 (“mandipropamid”) in WO 01/87822; compound B-5.2 in WO 98/46607; compound B-5.3 (“fluopicolide”) in WO 99/42447; compound B-5.4 (“cyflufenamid”) in WO 96/19442; compound B-5.5 in WO 99/14187; compound B-5.6 (“pyribencarb”) is registered under CAS-Reg. No.: 325156-49-8; compound B-5.7 (“amisulbrom” or “ambromdole”) is registered under CAS-Reg. No.: 348635-87-0; compound B-5.8 (3-difluoromethyl-1-methyl-1H-pyrazole-4-carboxylic acid (2-bicyclopropyl-2-yl-phenyl)-amide) is described in WO 03/74491; compound B-5.9 (3-difluoromethyl-1-methyl-1H-pyrazole-4-carboxylic acid (9-isopropyp-1,2,3,4-tetrahydro-1,4-methano-naphthalen-5-yl)-amide) is described in WO 04/35589 and in WO 06/37632; compound B-5.10 (1,3-dimethyl-5-fluoro-1H-pyrazole-4-carboxylic acid [2-(1,3-dimethylbutyl)phenyl]-amide) is described in WO 03/10149; compound B-5.11 (3-difluoromethyl-1-methyl-1H-pyrazole-4-carboxylic acid (3′,4′-dichloro-5-fluoro-1,1′-biphenyl-2-yl)-amide; “bixafen”) is registered under CAS-Reg. No.: 581809-46-3 and described in WO 03/70705; compound B-5.12 (N-{2-[3-Chloro-5-(trifluoromethyl)pyridin-2-yl]ethyl}-2-(trifluoromethyl)benzamid; “fluopyram”) is registered under CAS-Reg. No.: 658066-35-4 and described in WO 04/16088; compounds B-5.13, B-5.14 and B-5.15 are described in WO 07/17450; compounds B-5.16, B-5.17 and B-5.18 are described in WO 06/120219; compound B-5.19 (“isopyrazam”) is described in WO04/035589, and in WO06/37632; compound B-5.20 is described in WO03/074491; compound B-7.1 (“rynaxypyr”) is described in WO 03/15519; compound B-7.2 is described in WO 04/67528; and pinoxaden is described in the “The e-Pesticide Manual” [The e-Pesticide Manual—A World Compendium; Fourteenth Edition; Version 4.0 2006-07—Editor: C. D. S. Tomlin; The British Crop Protection Council] under the entry number (668).

A subset of component (B) compounds is listed below and is identified hereinafter as Group P. Group P compounds are particularly suitable for the control of diseases caused by phytopthogens when combined to form the composition of the claimed invention. The Group P compounds are identified as follows:

(B1) a strobilurin fungicide selected from the group consisting of azoxystrobin and pyraclostrobin;

(B2) an azole fungicide selected from the group consisting of cyproconazole, difenoconazole, epoxiconazole, metconazole, penconazole, propiconazole, prothioconazole, tebuconazole;

(B3) a morpholine fungicide: fenpropidin;

(B4) an anilino-pyrimidine fungicide: cyprodinil;

(B5) a fungicide selected from the group consisting of boscalid, chlorothalonil, fludioxonil, mancozeb,

a compound of formula B-5.19

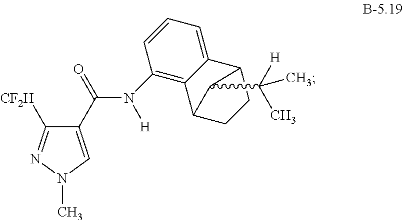

a compound of formula B-5.20

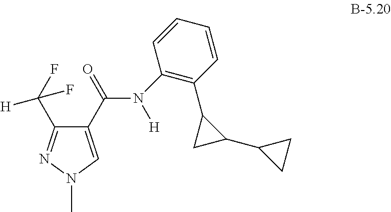

(B6) a plant-bioregulator selected from the group consisting of acibenzolar-5-methyl and trinexapac-ethyl;

(B7) an insecticide selected from the group consisting of thiamethoxam and lambda cyhalothrin; and

(B8) a herbicide selected from the group consisting of glyphosate, clodinafop propargyl and pinoxaden.

In another embodiment, the novel compositions suitable for control of diseases caused by phytopathogens comprise

(A) a compound of formula I

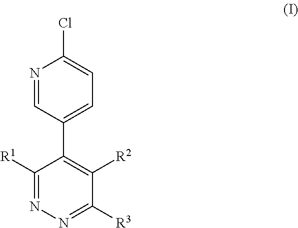

wherein
R¹ is methyl, ethyl or isopropyl;
R² is 2-chloro-6-fluoro-phenyl, 2,4,6-trifluorophenyl or 2,6-difluoro-4-methoxy-phenyl;
R³ is chloro, fluoro or methoxy; and

(B) a compound selected from the group consisting of group P as defined above.

A second subset of component (B) compounds is listed below and is identified hereinafter as Group Q. Similar to Group P above, Group Q compounds have also been identified as having fungicidal properties that enhance the activity of the composition of the present invention. The compounds of Group Q include:

(B1) a strobilurin fungicide: azoxystrobin;

(B2) an azole fungicide selected from the group consisting of cyproconazole, difenoconazole, epoxiconazole, propiconazole, prothioconazole;

(B4) an anilino-pyrimidine fungicide: cyprodinil;

(B5) a fungicide selected from the group consisting of chlorothalonil, mancozeb, a compound of formula B-5.19

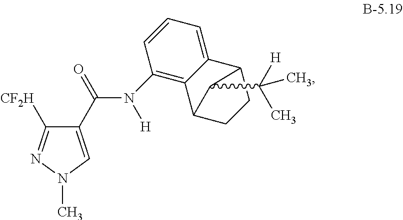

and

(B7) an insecticide: thiamethoxam.

In a further embodiment, the novel compositions suitable for control of diseases caused by phytopathogens comprise

(A) a compound of formula I

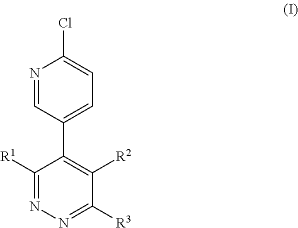

wherein
R¹ is methyl, ethyl or isopropyl;
R² is 2-chloro-6-fluoro-phenyl, 2,4,6-trifluorophenyl or 2,6-difluoro-4-methoxy-phenyl;
R³ is chloro, fluoro or methoxy; and

(B) a compound selected from the group consisting of group Q as defined above.

Throughout this document the expression “composition” stands for the various mixtures or combinations of components (A) and (B), for example in a single “ready-mix” form, in a combined spray mixture composed from separate formulations of the single active ingredient components, such as a “tank-mix”, and in a combined use of the single active ingredients when applied in a sequential manner, i.e. one after the other with a reasonably short period, such as a few hours or days. The order of applying the components (A) and (B) is not essential for working the present invention.

The compositions according to the invention may also comprise more than one of the active components (B), if, for example, a broadening of the spectrum of phytopathogenic disease control is desired. For instance, it may be advantageous in the agricultural practice to combine two or three components (B) with component (A). An example is a composition comprising a compound of formula (I), azoxystrobin and cyproconazole.

The following compositions are preferred.

A composition comprising (A) compound A-1.1 and (B) a compound selected from the group P. An example of such a composition is a composition comprising the compound A-1.1 and the first compound from the group P, which is azoxystrobin.

A composition comprising (A) compound A-1.1 and (B) a compound selected from the group Q. An example of such a composition is a composition comprising the compound A-1.1 and the second compound from the group Q, which is cyproconazole.

A composition comprising (A) compound A-1.1 and (B) a strobilurin fungicide.

A composition comprising (A) compound A-1.1 and (B) an azole fungicide.

A composition comprising (A) compound A-1.1 and (B) a morpholine fungicide.

A composition comprising (A) compound A-1.1 and (B) an anilinopyrimidine fungicide.

A composition comprising (A) compound A-1.1 and (B) a plant-bioregulator selected from the group consisting of acibenzolar-5-methyl and trinexapac-ethyl.

A composition comprising (A) compound A-1.1 and the insecticide selected from the group consisting of thiamethoxam and lambda cyhalothrin.

A composition comprising (A) compound A-1.1 and (B) a herbicide selected from the group consisting of glyphosate, clodinafop propargyl and pinoxaden.

A composition comprising (A) compound A-1.1 and a fungicide selected from azoxystrobin, pyraclostrobin, cyproconazole, difenoconazole, epoxiconazole, metconazole, penconazole, propiconazole, prothioconazole, tebuconazole, fenpropidin, cyprodinil, boscalid, chlorothalonil, fludioxonil, mancozeb, a compound of formula B-5.19 and a compound of formula B-5.20.

A composition comprising (A) compound A-1.1 and a fungicide selected from azoxystrobin, cyproconazole, difenoconazole, epoxiconazole, prothioconazole, cyprodinil, chlorothalonil, mancozeb and a compound of formula B-5.19.

A composition comprising (A) compound A-1.2 and (B) a compound selected from the group P.

A composition comprising (A) compound A-1.2 and (B) a compound selected from the group Q.

A composition comprising (A) compound A-1.2 and (B) a strobilurin fungicide.

A composition comprising (A) compound A-1.2 and (B) an azole fungicide.

A composition comprising (A) compound A-1.2 and (B) a morpholine fungicide.

A composition comprising (A) compound A-1.2 and (B) an anilinopyrimidine fungicide.

A composition comprising (A) compound A-1.2 and (B) a plant-bioregulator selected from the group consisting of acibenzolar-5-methyl and trinexapac-ethyl.

A composition comprising (A) compound A-1.2 and the insecticide selected from the group consisting of thiamethoxam and lambda cyhalothrin.

A composition comprising (A) compound A-1.2 and (B) a herbicide selected from the group consisting of glyphosate, clodinafop propargyl and pinoxaden.

A composition comprising (A) compound A-1.2 and a fungicide selected from azoxystrobin, pyraclostrobin, cyproconazole, difenoconazole, epoxiconazole, metconazole, penconazole, propiconazole, prothioconazole, tebuconazole, fenpropidin, cyprodinil, boscalid, chlorothalonil, fludioxonil, mancozeb, a compound of formula B-5.19 and a compound of formula B-5.20.

A composition comprising (A) compound A-1.2 and a fungicide selected from azoxystrobin, cyproconazole, difenoconazole, epoxiconazole, prothioconazole, cyprodinil, chlorothalonil, mancozeb and a compound of formula B-5.19.

A composition comprising (A) compound A-1.3 and (B) a compound selected from the group P.

A composition comprising (A) compound A-1.3 and (B) a compound selected from the group Q.

A composition comprising (A) compound A-1.3 and (B) a strobilurin fungicide.

A composition comprising (A) compound A-1.3 and (B) an azole fungicide.

A composition comprising (A) compound A-1.3 and (B) a morpholine fungicide.

A composition comprising (A) compound A-1.3 and (B) an anilinopyrimidine fungicide.

A composition comprising (A) compound A-1.3 and (B) a plant-bioregulator selected from the group consisting of acibenzolar-5-methyl and trinexapac-ethyl.

A composition comprising (A) compound A-1.3 and the insecticide selected from the group consisting of thiamethoxam and lambda cyhalothrin.

A composition comprising (A) compound A-1.3 and (B) a herbicide selected from the group consisting of glyphosate, clodinafop propargyl and pinoxaden.

A composition comprising (A) compound A-1.3 and a fungicide selected from azoxystrobin, pyraclostrobin, cyproconazole, difenoconazole, epoxiconazole, metconazole, penconazole, propiconazole, prothioconazole, tebuconazole, fenpropidin, cyprodinil, boscalid, chlorothalonil, fludioxonil, mancozeb, a compound of formula B-5.19 and a compound of formula B-5.20.

A composition comprising (A) compound A-1.3 and a fungicide selected from azoxystrobin, cyproconazole, difenoconazole, epoxiconazole, prothioconazole, cyprodinil, chlorothalonil, mancozeb and a compound of formula B-5.19.

The compositions according to the invention are effective against harmful microorganisms, such as microorganisms, that cause phytopathogenic diseases, in particular against phytopathogenic fungi and bacteria.

The compositions according to the invention are effective especially against phytopathogenic fungi belonging to the following classes: Fungi imperfecti (e.g. Alternaria spp.), Basidiomycetes (e.g. Corticium spp., Ceratobasidium spp., Waitea spp., Thanatephorus spp., Rhizoctonia spp., Hemileia spp., Puccinia spp., Phakopsora spp., Ustilago spp., Tilletia spp.), Ascomycetes (e.g. Venturia spp., Blumeria spp., Etysiphe spp., Podosphaera spp., Uncinula spp., Monilinia spp., Sclerotinia spp., Colletotrichum spp., Glomerella spp., Fusarium spp., Gibberella spp., Monographella spp., Phaeosphaeria spp., Mycosphaerella spp., Cercospora spp., Pyrenophora spp., Rhynchosporium spp., Magnaporthe spp., Gaeumannomyces spp., Oculimacula spp., Ramularia spp., Bottyotinia spp.) and Oomycetes (e.g. Phytophthora spp., Pythium spp., Plasmopara spp., Peronospora spp., Pseudoperonospora spp., Bremia spp). Outstanding activity has been observed against powdery mildews (e.g. Uncinula necator), rusts (e.g. Puccinia spp.) and leaf spots (e.g. Mycosphaerella spp.). Furthermore, the compositions are effective against phytopathogenic gram negative and gram positive bacteria (e.g. Xanthomonas spp, Pseudomonas spp, Erwinia amylovora, Ralstonia spp.) and viruses (e.g. tobacco mosaic virus).

According to the invention “useful plants” are typically from any of the following plant groupings: cereals (wheat, barley, rye, oat, rice, maize, sorghum and related species); beets (sugar beet and fodder beet); pomes, drupes and soft fruit (apples, pears, plums, peaches, almonds, cherries, strawberries, raspberries and blackberries); leguminous plants (beans, lentils, peas, soybeans); oil plants (rape, mustard, poppy, olives, sunflowers, coconut, castor oil plants, cocoa beans, groundnuts); cucurbit plants (pumpkins, cucumbers, melons); fibre plants (cotton, flax, hemp, jute); citrus fruit (oranges, lemons, grapefruit, mandarins); vegetables (spinach, lettuce, asparagus, cabbages, carrots, onions, tomatoes, potatoes, paprika); lauraceae (avocado, cinnamomum, camphor) or plants such as tobacco, nuts, coffee, eggplants, sugar cane, tea, pepper, vines, hops, bananas and natural rubber plants, as well as ornamentals.; turf or ornamentals, such as flowers, shrubs, broad-leaved trees or evergreens, for example conifers. This list does not represent any limitation.

The term “useful plants” is to be understood as including also useful plants that have been rendered tolerant to herbicides like bromoxynil or classes of herbicides (such as, for example, HPPD inhibitors, ALS inhibitors, for example primisulfuron, prosulfuron and trifloxysulfuron, EPSPS (5-enol-pyrovyl-shikimate-3-phosphate-synthase) inhibitors, GS (glutamine synthetase) inhibitors or PPO (protoporphyrinogen-oxidase) inhibitors) as a result of conventional methods of breeding or genetic engineering. An example of a crop that has been rendered tolerant to imidazolinones, e.g. imazamox, by conventional methods of breeding (mutagenesis) is Clearfield® summer rape (Canola). Examples of crops that have been rendered tolerant to herbicides or classes of herbicides by genetic engineering methods include glyphosate- and glufosinate-resistant maize varieties commercially available under the trade names RoundupReady®, Herculex I® and LibertyLink®.

The term “useful plants” is to be understood as including also useful plants which have been so transformed by the use of recombinant DNA techniques that they are capable of synthesising one or more selectively acting toxins, such as are known, for example, from toxin-producing bacteria, especially those of the genus Bacillus.

The term “useful plants” is to be understood as including also useful plants which have been so transformed by the use of recombinant DNA techniques that they are capable of synthesising antipathogenic substances having a selective action, such as, for example, the so-called “pathogenesis-related proteins” (PRPs, see e.g. EP-A-0 392 225). Examples of such antipathogenic substances and transgenic plants capable of synthesising such antipathogenic substances are known, for example, from EP-A-0 392 225, WO 95/33818, and EP-A-0 353 191. The methods of producing such transgenic plants are generally known to the person skilled in the art and are described, for example, in the publications mentioned above.

The term “locus” of a useful plant as used herein is intended to embrace the place on which the useful plants are growing, where the plant propagation materials of the useful plants are sown or where the plant propagation materials of the useful plants will be placed into the soil. An example for such a locus is a field, on which crop plants are growing.

The term “plant propagation material” is understood to denote generative parts of the plant, such as seeds, which can be used for the multiplication of the latter, and vegetative material, such as cuttings or tubers, for example potatoes. There may be mentioned for example seeds (in the strict sense), roots, fruits, tubers, bulbs, rhizomes and parts of plants. Germinated plants and young plants which are to be transplanted after germination or after emergence from the soil, may also be mentioned. These young plants may be protected before transplantation by a total or partial treatment by immersion. Preferably “plant propagation material” is understood to denote seeds.

The compositions of the present invention may also be used in the field of protecting storage goods against attack of fungi. According to the present invention, the term “storage goods” is understood to denote natural substances of vegetable and/or animal origin and their processed forms, which are taken from the natural life cycle and for which long-term protection is desired. Storage goods of vegetable origin, such as plants or parts thereof, for example stalks, leafs, tubers, seeds, fruits or grains, can be protected in the freshly harvested state or in processed form, such as pre-dried, moistened, comminuted, ground, pressed or roasted. Also falling under the definition of storage goods is timber, whether in the form of crude timber, such as construction timber, electricity pylons and barriers, or in the form of finished articles, such as furniture or objects made from wood. Storage goods of animal origin are hides, leather, furs, hairs and the like. The compositions according the present invention can prevent disadvantageous effects such as decay, discoloration or mold. Preferably “storage goods” is understood to denote natural substances of vegetable origin and/or their processed forms, more preferably fruits and their processed forms, such as pomes, stone fruits, soft fruits and citrus fruits and their processed forms. In another preferred embodiment of the invention “storage goods” is understood to denote wood.

Therefore a further aspect of the present invention is a method of protecting storage goods, which comprises applying to the storage goods a composition according to the invention.

The compositions of the present invention may also be used in the field of protecting technical material against attack of fungi. According to the present invention, the term “technical material” includes paper; carpets; constructions; cooling and heating systems; wall-boards; ventilation and air conditioning systems and the like; preferably “technical material” is understood to denote wall-boards. The compositions according the present invention can prevent disadvantageous effects such as decay, discoloration or mold.

The compositions according to the invention are particularly effective against Alternaria spp. in potato, tomato and citrus fruits; Mycosphaerella spp. in wheat, groundnuts, soybeans and banana; Cercospora beticola in sugar beet; Phaeosphaeria nodorum in wheat; Rhizoctonia spp. in rice, turf and cotton; Puccinia spp. in wheat; Phakopsora pachyrhizi in soybeans; Venturia spp. in pomefruits; Bottyotinia spp. in various fruit and vegetables; Colletotrichum spp. in beans and cucurbits; Uncinula necator in grapevine; Fusarium spp, Monographella spp. and Gibberella spp. in cereals; and Pyrenophora spp. in wheat, barley and maize.

The compositions according to the invention are furthermore particularly effective against seedborne and soilborne diseases, such as Alternaria spp., Ascochyta spp., Bottyotinia spp., Ceratobasidium spp., Cercospora spp., Claviceps purpurea, Cochliobolus spp., Colletotrichum spp., Corticium spp., Didymella spp., Epicoccum spp., Fusarium spp., Gibberella spp., Glomerella spp., Gaumannomyces spp., Helminthosporium spp., Magnaporthe spp., Microdochium spp., Monographella spp., Mycosphaerella spp., Phaeosphaeria spp., Phoma spp., Phytophthora spp., Pythium spp., Pyrenophora spp., Ramularia spp., Rhizoctonia spp., Sclerotinia spp., Septoria spp., Sphacelotheca spp., Thanatephorus spp., Tilletia spp., Typhula spp., Urocystis spp., Ustilago spp, Verticillium spp. or Waitea spp.; in particular against pathogens of cereals, such as wheat, barley, rye or oats; maize; rice; cotton; groundnuts; soybean; turf; sugarbeet; oil seed rape; potatoes; pulse crops, such as peas, lentils or chickpea; and sunflower. The compositions according to the invention are furthermore particularly effective against post harvest diseases such as Bottyotinia spp., Colletotrichum spp., Cochliobolus spp., Fusarium spp., Geotrichum spp., Monilinia spp., Mucor spp., Penicillium spp. or Pezicula spp.; in particular against pathogens of fruits, such as pomefruits, for example apples and pears, stone fruits, for example peaches and plums, citrus, melons, papaya, kiwi, mango, berries, for example strawberries, avocados, pomegranates and bananas, and nuts.

In general, the weight ratio of component (A) to component (B) is from 2000:1 to 1:1000. A non-limiting example for such weight ratios is compound of formula I:compound of formula B-2 is 10:1. The weight ratio of component (A) to component (B) is preferably from 100:1 to 1:100; more preferably from 20:1 to 1:50.

Surprisingly, certain weight ratios of component (A) to component (B) are able to give rise to synergistic activity. Therefore, a further aspect of the invention are compositions, wherein component (A) and component (B) are present in the composition in amounts producing a synergistic effect. This synergistic activity is apparent from the fact that the fungicidal activity of the composition comprising component (A) and component (B) is greater than the sum of the fungicidal activities of component (A) and of component (B). This synergistic activity extends the range of action of component (A) and component (B) in two ways. Firstly, the rates of application of component (A) and component (B) are lowered whilst the action remains equally good, meaning that the active ingredient mixture still achieves a high degree of phytopathogen control even where the two individual components have become totally ineffective in such a low application rate range. Secondly, there is a substantial broadening of the spectrum of phytopathogens that can be well controlled.

A synergistic effect exists whenever the action of an active ingredient combination is greater than the sum of the actions of the individual components. The action to be expected E for a given active ingredient combination obeys the so-called COLBY formula and can be calculated as follows (COLBY, S. R. “Calculating synergistic and antagonistic responses of herbicide combination”. Weeds, Vol. 15, pages 20-22; 1967):

ppm=milligrams of active ingredient (=a.i.) per liter of spray mixture
X=% action by active ingredient A) using p ppm of active ingredient
Y=% action by active ingredient B) using q ppm of active ingredient.
According to COLBY, the expected (additive) action of active ingredients A)+B) using
p+q ppm of active ingredient is

$$E = X + Y - \frac{X \cdot Y}{100}$$

If the action actually observed (O) is greater than the expected action (E), then the action of the combination is super-additive, i.e. there is a synergistic effect. In mathematical terms, synergism corresponds to a positive value for the difference of (O-E). In the case of purely complementary addition of activities (expected activity), said difference (O-E) is zero. A negative value of said difference (O-E) signals a loss of activity compared to the expected activity.

However, besides the actual synergistic action with respect to fungicidal activity, the compositions according to the invention can also have further surprising advantageous properties. Examples of such advantageous properties that may be mentioned are: more advantageuos degradability; improved toxicological and/or ecotoxicological behaviour; or improved characteristics of the useful plants including: emergence, crop yields, more developed root system, tillering increase, increase in plant height, bigger leaf blade, less dead basal leaves, stronger tillers, greener leaf colour, less fertilizers needed, less seeds needed, more productive tillers, earlier flowering, early grain maturity, less plant verse (lodging), increased shoot growth, improved plant vigor, and early germination.

Some compositions according to the invention have a systemic action and can be used as foliar, soil and seed treatment fungicides.

With the compositions according to the invention it is possible to inhibit or destroy the phytopathogenic microorganisms which occur in plants or in parts of plants (fruit, blossoms, leaves, stems, tubers, roots) in different useful plants, while at the same time the parts of plants which grow later are also protected from attack by phytopathogenic microorganisms.

The compositions according to the invention can be applied to the phytopathogenic microorganisms, the useful plants, the locus thereof, the propagation material thereof, storage goods or technical materials threatened by microorganism attack.

The compositions according to the invention may be applied before or after infection of the useful plants, the propagation material thereof, storage goods or technical materials by the microorganisms.

The amount of a composition according to the invention to be applied, will depend on various factors, such as the compounds employed; the subject of the treatment, such as, for example plants, soil or seeds; the type of treatment, such as, for example spraying, dusting or seed dressing; the purpose of the treatment, such as, for example prophylactic or therapeutic; the type of fungi to be controlled or the application time.

When applied to the useful plants component (A) is typically applied at a rate of 5 to 2000 g a.i./ha, particularly 10 to 1000 g a.i./ha, e.g. 50, 75, 100 or 200 g a.i./ha, typically in association with 1 to 5000 g a.i./ha, particularly 2 to 2000 g a.i./ha, e.g. 50, 100, 250, 500, 800, 1000, 1500 g a.i./ha of component (B).

In agricultural practice the application rates of the compositions according to the invention depend on the type of effect desired, and typically range from 20 to 4000 g of total composition per hectare.

When the compositions according to the invention are used for treating seed, rates of 0.001 to 50 g of a compound of component (A) per kg of seed, preferably from 0.01 to 10 g per kg of seed, and 0.001 to 50 g of a compound of component (B), per kg of seed, preferably from 0.01 to 10 g per kg of seed, are generally sufficient.

The composition of the invention may be employed in any conventional form, for example in the form of a twin pack, a powder for dry seed treatment (DS), an emulsion for seed treatment (ES), a flowable concentrate for seed treatment (FS), a solution for seed treatment (LS), a water dispersible powder for seed treatment (WS), a capsule suspension for seed treatment (CF), a gel for seed treatment (GF), an emulsion concentrate (EC), a suspension concentrate (SC), a suspo-emulsion (SE), a capsule suspension (CS), a water dispersible granule (WG), an emulsifiable granule (EG), an emulsion, water in oil (EO), an emulsion, oil in water (EW), a micro-emulsion (ME), an oil dispersion (OD), an oil miscible flowable (OF), an oil miscible liquid (OL), a soluble concentrate (SL), an ultra-low volume suspension (SU), an ultra-low volume liquid (UL), a technical concentrate (TK), a dispersible concentrate (DC), a wettable powder (WP) or any technically feasible formulation in combination with agriculturally acceptable adjuvants.

Such compositions may be produced in conventional manner, e.g. by mixing the active ingredients with at least one appropriate inert formulation adjuvant (for example, diluents, solvents, fillers and optionally other formulating ingredients such as surfactants, biocides, anti-freeze, stickers, thickeners and compounds that provide adjuvancy effects). Also conventional slow release formulations may be employed where long lasting efficacy is intended. Particularly formulations to be applied in spraying forms, such as water dispersible concentrates (e.g. EC, SC, DC, OD, SE, EW, EO and the like), wettable powders and granules, may contain surfactants such as wetting and dispersing agents and other compounds that provide adjuvancy effects, e.g. the condensation product of formaldehyde with naphthalene sulphonate, an alkylarylsulphonate, a lignin sulphonate, a fatty alkyl sulphate, and ethoxylated alkylphenol and an ethoxylated fatty alcohol.

The compositions according to the invention may also comprise further pesticides, such as, for example, fungicides, insecticides or herbicides.

A seed dressing formulation is applied in a manner known per se to the seeds employing the compositions according to the invention and a diluent in suitable seed dressing formulation form, e.g. as an aqueous suspension or in a dry powder form having good adherence to the seeds. Such seed dressing formulations are known in the art. Seed dressing formulations may contain the single active ingredients or the combination of active ingredients in encapsulated form, e.g. as slow release capsules or microcapsules.

In general, the formulations include from 0.01 to 90% by weight of active agent, from 0 to 20% agriculturally acceptable surfactant and 10 to 99.99% solid or liquid formulation inerts and adjuvant(s), the active agent consisting of at least a compound of component (A) together with a compound of component (B), and optionally other active agents, particularly microbiocides or conservatives or the like. Concentrated forms of compositions generally contain in between about 2 and 80%, preferably between about 5 and 70% by weight of active agent. Application forms of formulation may for example contain from 0.001 to 20% by weight, preferably from 0.01 to 5% by weight of active agent. Whereas commercial products will preferably be formulated as concentrates, the end user will normally employ diluted formulations.

The Examples which follow serve to illustrate the invention, “active ingredient” denotes a mixture of component (A) and component (B) in a specific mixing ratio. The same formulations can be used for compositions comprising only a compound of formula (I) as the active ingredient.

### Formulation Examples

| Wettable powders | a) | b) |
|---|---|---|
| active ingredient [A):B) = 1:3(a), 1:1(b)] | 25% | 75% |
| sodium lignosulfonate | 5% | — |
| sodium lauryl sulfate | 3% | 5% |
| sodium diisobutylnaphthalenesulfonate | — | 10% |
| (7-8 mol of ethylene oxide) | | |
| highly dispersed silicic acid | 5% | 10% |
| kaolin | 62% | — |

The active ingredient is thoroughly mixed with the other formulation components and the mixture is thoroughly ground in a suitable mill, affording wettable powders that can be diluted with water to give suspensions of the desired concentration.

| Powders for dry seed treatment | a) | b) |
|---|---|---|
| active ingredient [A):B) = 1:3(a), 1:1(b)] | 25% | 75% |
| light mineral oil | 5% | 5% |
| highly dispersed silicic acid | 5% | — |
| kaolin | 65% | — |
| talc | — | 20 |

The active ingredient is thoroughly mixed with the other formulation components and the mixture is thoroughly ground in a suitable mill, affording powders that can be used directly for seed treatment.

Emulsifiable concentrate

| | |
|---|---|
| active ingredient (A):B) = 1:6) | 10% |
| octylphenol polyethylene glycol ether | 3% |
| (4-5 mol of ethylene oxide) | |
| calcium dodecylbenzenesulfonate | 3% |
| castor oil polyglycol ether (35 mol of ethylene oxide) | 4% |
| cyclohexanone | 30% |
| xylene mixture | 50% |

Emulsions of any required dilution, which can be used in plant protection, can be obtained from this concentrate by dilution with water.

| Dustable powders | a) | b) |
|---|---|---|
| active ingredient [A):B) = 1:6(a), 1:10(b)] | 5% | 6% |
| talcum | 95% | — |
| kaolin | — | 94% |

Ready-for-use dusts are obtained by mixing the active ingredient with the carriers and grinding the mixture in a suitable mill. Such powders can also be used for dry dressings for seed.

| Extruded granules | % w/w |
|---|---|
| active ingredient (A):B) = 2:1) | 15% |
| sodium lignosulfonate | 2% |
| sodium alkyl naphthalene sulfonate | 1% |
| kaolin | 82% |

The active ingredient is mixed and ground with the other formulation components, and the mixture is moistened with water. The mixture is extruded and then dried in a stream of air.

Suspension concentrate

| | |
|---|---|
| active ingredient (A):B) = 1:8) | 40% |
| propylene glycol | 10% |
| nonylphenol polyethylene glycol ether (15 mol of ethylene oxide) | 6% |
| sodium lignosulfonate | 10% |
| carboxymethylcellulose | 1% |
| silicone oil (in the form of a 75% emulsion in water) | 1% |
| water | 32% |

The finely ground active ingredient is intimately mixed with the other formulation components, giving a suspension concentrate which can be diluted in water at any desired rate. Using such dilutions, living plants as well as plant propagation material can be treated and protected against infestation by microorganisms, by spraying, pouring or immersion.

Flowable concentrate for seed treatment

| | |
|---|---|
| active ingredient (A):B) = 1:8) | 40% |
| propylene glycol | 5% |
| copolymer butanol PO/EO | 2% |
| tristyrenephenole ethoxylate (with 10-20 moles EO) | 2% |
| 1,2-benzisothiazolin-3-one | 0.5% |
| monoazo-pigment calcium salt | 5% |
| silicone oil (in the form of a 75% emulsion in water) | 0.2% |
| water | 45.3% |

The finely ground active ingredient is intimately mixed with the other formulation components, giving a suspension concentrate which can be diluted further in water to be applied to seeds. Using such dilutions, propagation material can be treated and protected against infestation by microorganisms, by spraying, pouring or immersion.

### Biological Examples

Mycosphaerella graminicola (Septoria tritici; SEPTTR): Conidia of the fungus from cryogenic storage are directly mixed into nutrient broth (PDB potato dextrose broth). After placing a (DMSO) solution of the test compounds into a microtiter plate (96-well format) the nutrient broth containing the fungal spores is added. The test plates are incubated at 24° C. and the inhibition of growth is determined photometrically after 4 days.

Control of Mycosphaerella graminicola (Septoria tritici; SEPTTR)
Dosage in mg active ingredient/liter final medium

| | | Observed | Expected | Synergistic |
|---|---|---|---|---|
| Compound | | control | control | benefit in % |
| A-1.1 | | in % | in % | control |
| (ppm ai) | | (% C_{obs}) | (% Cₑₓₚ) | % C_{obs} − % Cₑₓₚ |
| [mg/L] | | observed | expected | difference |
| | Chlorothalonil | | | |
| | (ppm ai) | | | |
| | [mg/L] | | | |
| 0.0156 | — | 1.4 | — | — |
| 0.0313 | — | 3.7 | — | — |
| 0.0625 | — | 14.9 | — | — |
| 0.125 | — | 59.1 | — | — |
| — | 0.0039 | 3.0 | — | — |
| — | 0.0078 | 0.0 | — | — |
| — | 0.0156 | 0.7 | — | — |
| — | 0.0313 | 0.0 | — | — |
| 0.0156 | 0.0039 | 20.4 | 4.4 | +16.0 |
| 0.0313 | 0.0078 | 32.3 | 3.7 | +28.6 |
| 0.0625 | 0.0156 | 87.8 | 15.6 | +72.2 |
| 0.125 | 0.0313 | 99.4 | 59.1 | +40.4 |
| | Cyproconazole | | | |
| | (ppm ai) | | | |
| | [mg/L] | | | |
| 0.0156 | — | 0.3 | — | — |
| 0.0313 | — | 5.3 | — | — |
| 0.0625 | — | 13.0 | — | — |
| 0.125 | — | 67.2 | — | — |
| — | 0.0039 | 2.3 | — | — |
| — | 0.0078 | 2.8 | — | — |
| — | 0.0156 | 4.7 | — | — |
| — | 0.0313 | 1.9 | — | — |
| — | 0.0625 | 0.6 | — | — |
| 0.0156 | 0.0039 | 16.7 | 2.6 | +14.1 |
| 0.0313 | 0.0078 | 28.7 | 8.0 | +20.7 |
| 0.0625 | 0.0156 | 83.4 | 17.1 | +66.3 |
| 0.125 | 0.0313 | 99.4 | 67.8 | +31.6 |
| 0.0625 | 0.0313 | 51.3 | 14.6 | +36.6 |
| 0.125 | 0.0625 | 98.8 | 67.4 | +31.4 |
| | Epoxiconazole | | | |
| | (ppm ai) | | | |
| | [mg/L] | | | |
| 0.0156 | — | 1.6 | — | — |
| 0.0625 | — | 15.1 | — | — |
| 0.125 | — | 58.5 | — | — |
| — | 0.0625 | 6.8 | — | — |
| — | 0.125 | 18.0 | — | — |
| — | 0.25 | 36.8 | — | — |
| — | 0.5 | 51.8 | — | — |
| 0.0625 | 0.0625 | 31.5 | 20.9 | +10.6 |
| 0.125 | 0.125 | 95.1 | 66.0 | +29.1 |
| 0.125 | 0.25 | 96.8 | 73.7 | +23.1 |
| 0.0156 | 0.0625 | 42.6 | 8.3 | +34.3 |
| 0.0625 | 0.25 | 93.7 | 46.3 | +47.4 |
| 0.125 | 0.5 | 99.3 | 80.0 | +19.3 |
| | Thiomethoxam | | | |
| | (ppm ai) | | | |
| | [mg/L] | | | |
| 0.0156 | — | 3.4 | — | — |
| 0.0313 | — | 6.3 | — | — |
| 0.0625 | — | 13.7 | — | — |
| 0.125 | — | 80.1 | — | — |
| — | 0.0039 | 1.8 | — | — |
| — | 0.0078 | 1.6 | — | — |
| — | 0.0156 | 0.0 | — | — |
| — | 0.0313 | 2.9 | — | — |
| — | 0.0625 | 0.0 | — | — |
| 0.0156 | 0.0039 | 32.6 | 5.1 | +27.4 |
| 0.0313 | 0.0078 | 46.6 | 7.8 | +38.8 |
| 0.0625 | 0.0156 | 81.0 | 13.7 | +67.3 |
| 0.125 | 0.0313 | 99.0 | 80.7 | +18.3 |
| 0.0313 | 0.0156 | 19.1 | 6.3 | +12.8 |
| 0.0625 | 0.0313 | 61.5 | 16.2 | +45.2 |
| 0.125 | 0.0625 | 98.9 | 80.1 | +18.7 |

Mycosphaerella arachidis (Cercospora arachidicola; MYCOAR): Conidia of the fungus from cryogenic storage are directly mixed into nutrient broth (PDB potato dextrose broth). After placing a (DMSO) solution of the test compounds into a microtiter plate (96-well format) the nutrient broth containing the fungal spores is added. The test plates are incubated at 24° C. and the inhibition of growth is determined photometrically after 8 days at 620 nm.

Control of Mycosphaerella arachidis
(Cercospora arachidicola; MYCOAR)
Dosage in mg active ingredient/liter final medium

| | | | | Synergistic |
|---|---|---|---|---|
| | | Observed | Expected | benefit in % |
| Compound | | control | control | control |
| A-1.1 | | in % | in % | % C_{obs} − |
| (ppm ai) | | (% C_{obs}) | (% Cₑₓₚ) | % Cₑₓₚ |
| [mg/L] | | observed | expected | difference |
| | Chlorothalonil | | | |
| | (ppm ai) | | | |
| | [mg/L] | | | |
| 0.125 | — | 19.7 | — | — |
| 0.25 | — | 51.3 | — | — |
| — | 0.0313 | 7.6 | — | — |
| — | 0.0625 | 8.2 | — | — |
| — | 0.125 | 9.9 | — | — |
| 0.125 | 0.0313 | 49.9 | 25.8 | +24.0 |
| 0.25 | 0.0625 | 100 | 55.3 | +44.7 |
| 0.125 | 0.0625 | 41.3 | 26.3 | +14.9 |
| 0.25 | 0.125 | 100 | 56.1 | +43.9 |
| | Azoxystrobin | | | |
| | (ppm ai) | | | |
| | [mg/L] | | | |
| 0.125 | — | 6.8 | — | — |
| 0.25 | — | 56.5 | — | — |
| — | 0.0313 | 44.8 | — | — |
| — | 0.0625 | 76.4 | — | — |
| 0.125 | 0.0313 | 83.0 | 48.5 | +34.5 |
| 0.25 | 0.0625 | 100 | 89.8 | +10.2 |
| | Difenoconazole | | | |
| | (ppm ai) | | | |
| | [mg/L] | | | |
| 0.0625 | — | 3.5 | — | — |
| — | 0.0156 | 66.5 | — | — |
| 0.0625 | 0.0156 | 100 | 67.7 | +32.3 |
| | Prothioconazole | | | |
| | (ppm ai) | | | |
| | [mg/L] | | | |
| 0.0313 | — | 6.7 | — | — |
| 0.0625 | — | 5.1 | — | — |
| 0.125 | — | 20.9 | — | — |
| — | 0.0156 | 22.0 | — | — |
| — | 0.0313 | 59.1 | — | — |
| 0.0625 | 0.0156 | 72.2 | 26.0 | +46.2 |
| 0.125 | 0.0313 | 100 | 67.6 | +32.4 |
| 0.0313 | 0.0156 | 38.1 | 27.2 | +10.9 |
| 0.0625 | 0.0313 | 97.6 | 61.2 | +36.4 |

Alternaria solani (ALTESO): Conidia harvested from a freshly grown colony of the fungus are directly mixed into nutrient broth (PDB potato dextrose broth). After placing a (DMSO) solution of the test compounds into a microtiter plate (96-well format) the nutrient broth containing the fungal spores is added. The test plates are incubated at 24° C. and the inhibition of growth is determined photometrically after 3 days.

Control of Alternaria solani; ALTESO
Dosage in mg active ingredient/liter final medium

| | | Observed | Expected | Synergistic |
|---|---|---|---|---|
| Compound | | control | control | benefit in % |
| A-1.1 | | in % | in % | control |
| (ppm ai) | | (% C_{obs}) | (% Cₑₓₚ) | % C_{obs} − % Cₑₓₚ |
| [mg/L] | | observed | expected | difference |
| | Difenoconazole | | | |
| | (ppm ai) | | | |
| | [mg/L] | | | |
| 0.25 | — | 13.3 | — | — |
| 0.5 | — | 28.4 | — | — |
| — | 0.0625 | 37.6 | — | — |
| — | 0.125 | 36.9 | — | — |
| 0.25 | 0.0625 | 68.2 | 45.9 | +22.3 |
| 0.5 | 0.125 | 97.5 | 54.9 | +42.7 |
| | Epoxiconazole | | | |
| | (ppm ai) | | | |
| | [mg/L] | | | |
| 0.25 | — | 7.0 | — | — |
| 0.5 | — | 39.9 | — | — |
| — | 0.0625 | 0.0 | — | — |
| — | 0.125 | 24.3 | — | — |
| — | 0.25 | 28.9 | — | — |
| 0.25 | 0.0625 | 34.4 | 7.0 | +27.4 |
| 0.5 | 0.125 | 69.1 | 54.5 | +14.6 |
| 0.25 | 0.125 | 52.4 | 29.7 | +22.8 |
| 0.5 | 0.25 | 93.2 | 57.3 | +36.0 |
| | Mancozeb | | | |
| | (ppm ai) | | | |
| | [mg/L] | | | |
| 1.0 | — | 38.8 | — | — |
| — | 0.25 | 0.7 | — | — |
| 1.0 | 0.25 | 83.3 | 39.3 | +44.1 |

Pyrenophora teres (PYRNTE): Conidia of the fungus from cryogenic storage are directly mixed into nutrient broth (PDB potato dextrose broth). After placing a (DMSO) solution of the test compounds into a microtiter plate (96-well format) the nutrient broth containing the fungal spores is added. The test plates are incubated at 24° C. and the inhibition of growth is determined photometrically after 3 days.

Control of Pyrenophora teres; PYRNTE
Dosage in mg active ingredient/liter final medium

| | | | | Synergistic |
|---|---|---|---|---|
| | | Observed | Expected | benefit in % |
| Compound | | control | control | control |
| A-1.1 | | in % | in % | % C_{obs} − |
| (ppm ai) | | (% C_{obs}) | (% Cₑₓₚ) | % Cₑₓₚ |
| [mg/L] | | observed | expected | difference |
| | Cyprodinil | | | |
| | (ppm ai) | | | |
| | [mg/L] | | | |
| 0.25 | — | 18.4 | — | — |
| 0.5 | — | 21.7 | — | — |
| — | 0.0625 | 23.8 | — | — |
| — | 0.125 | 45.1 | — | — |
| 0.25 | 0.0625 | 48.3 | 37.8 | +10.6 |
| 0.5 | 0.125 | 83.9 | 57.0 | +27.0 |
| | Cyproconazole | | | |
| | (ppm ai) | | | |
| | [mg/L] | | | |
| 0.25 | — | 2.8 | — | — |
| 0.5 | — | 32.6 | — | — |
| — | 0.0625 | 0.0 | — | — |
| — | 0.125 | 0.0 | — | — |
| — | 0.25 | 15.1 | — | — |
| 0.25 | 0.0625 | 14.1 | 2.8 | +11.3 |
| 0.5 | 0.125 | 57.1 | 32.6 | +24.5 |
| 0.25 | 0.125 | 20.2 | 2.8 | +17.5 |
| 0.5 | 0.25 | 63.0 | 42.8 | +20.2 |
| | Prothioconazole | | | |
| | (ppm ai) | | | |
| | [mg/L] | | | |
| 0.25 | — | 10.8 | — | — |
| 0.5 | — | 34.2 | — | — |
| — | 0.0625 | 28.9 | — | — |
| — | 0.125 | 50.1 | — | — |
| — | 0.25 | 66.6 | — | — |
| 0.25 | 0.0625 | 53.3 | 36.6 | +16.7 |
| 0.5 | 0.125 | 91.6 | 67.2 | +24.4 |
| 0.25 | 0.125 | 76.0 | 55.5 | +20.5 |
| 0.5 | 0.25 | 92.5 | 78.1 | +14.4 |
| | Thiomethoxam | | | |
| | (ppm ai) | | | |
| | [mg/L] | | | |
| 0.25 | — | 9.8 | — | — |
| 0.5 | — | 45.2 | — | — |
| — | 0.0625 | 0.0 | — | — |
| — | 0.125 | 0.0 | — | — |
| — | 0.25 | 0.0 | — | — |
| 0.25 | 0.0625 | 23.8 | 9.8 | +14.0 |
| 0.5 | 0.125 | 82.3 | 45.2 | +37.0 |
| 0.25 | 0.125 | 26.8 | 9.8 | +17.0 |
| 0.5 | 0.25 | 93.0 | 45.2 | +47.8 |

The combinations according to the above biological examples exhibit a good activity.

What is claimed is:

1. A fungicidal composition suitable for control of diseases caused by phytopathogens comprising:
(A) a compound of formula I 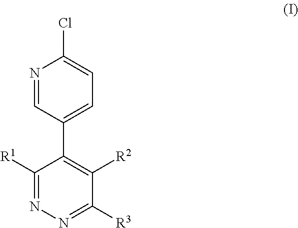
wherein
R¹ is methyl, ethyl or isopropyl;
R² is 2-chloro-6-fluoro-phenyl, 2,4,6-trifluorophenyl or 2,6-difluoro-4-methoxy-phenyl;
R³ is chloro, fluoro or methoxy; and
(B) a compound selected from the group consisting of
(B1) a strobilurin fungicide,
(B2) an azole fungicide,
(B3) a morpholine fungicide,
(B4) an anilinopyrimidine fungicide,
(B5) a fungicide selected from the group consisting of
anilazine, arsenates, benalaxyl, benalaxyl-M, benodanil, benomyl, benthiavalicarb, benthiavalicarb-isopropyl, biphenyl, bitertanol, blasticidin-S, bordeaux mixture, boscalid, bupirimate, cadmium chloride, captafol, captan, carbendazim, carbon disulfide, carboxin, carpropamid, cedar leaf oil, chino-methionat, chlorine, chloroneb, chlorothalonil, chlozolinate, cinnamaldehyde, copper, copper ammoniumcarbonate, copper hydroxide, copper octanoate, copper oleate, copper sulphate, cyazofamid, cycloheximide, cymoxanil, dichlofluanid, dichlone, dichloropropene, diclocymet, diclomezine, dicloran, diethofencarb, diflumetorim, dimethirimol, dimethomorph, dinocap, dithianon, dodine, edifenphos, ethaboxam, ethirimol, etridiazole, famoxadone, fenamidone, fenaminosulf, fenamiphos, fenarimol, fenfuram, fenhexamid, fenoxanil, fenpiclonil, fentin acetate, fentin chloride, fentin hydroxide, ferbam, ferimzone, fluazinam, fludioxonil, flusulfamide, flutolanil, folpet, formaldehyde, fosetyl-aluminium, fthalide, fuberidazole, furalaxyl, furametpyr, flyodin, fuazatine, hexachlorobenzene, hymexazole, iminoctadine, iodocarb, iprobenfos, iprodione, iprovalicarb, isoprothiolane, kasugamycin, mancozeb, maneb, manganous dimethyldithiocarbamate, mefenoxam, mepronil, mercuric chloride, mercury, metalaxyl, methasulfocarb, metiram, metrafenone, nabam, neem oil, nuarimol, octhilinone, ofurace, oxadixyl, oxine copper, oxolinic acid, oxycarboxin, oxytetracycline, paclobutrazole, paraffin oil, paraformaldehyde, pencycuron, pentachloronitrobenzene, pentachlorophenol, penthiopyrad, perfurazoate, phosphoric acid, polyoxin, polyoxin D zinc salt, potassium bicarbonate, probenazole, procymidone, propamocarb, propineb, proquinazid, prothiocarb, pyrazophos, pyrifenox, pyroquilon, quinoxyfen, quintozene, silthiofam, sodium bicarbonate, sodium diacetate, sodium propionate, streptomycin, sulphur, TCMTB, tecloftalam, tecnazene, thiabendazole, thifluzamide, thiophanate, thiophanate-methyl, thiram, toiclofos-methyl, tolylfluanid, triazoxide, trichoderma harzianum, tricyclazole, triforine, triphenyltin hydroxide, validamycin, vinclozolin, zineb, ziram, zoxamide, 1,1-bis(4-chlorophenyl)-2-ethoxyethanol, 2,4-dichlorophenyl benzenesulfonate, 2-fluoro-N-methyl-N-1-naphthylacetamide, 4-chlorophenyl phenyl sulfone,
a compound of formula B-5.1 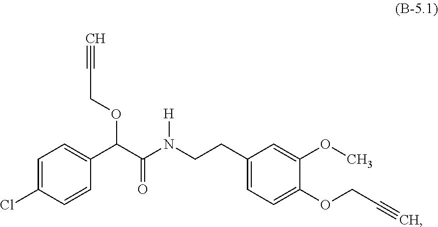
a compound of formula B-5.2 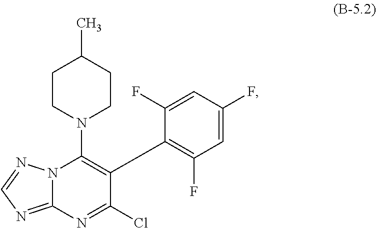
a compound of formula B-5.3 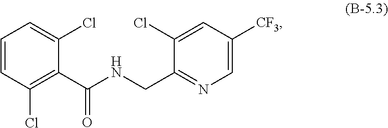
a compound of formula B-5.4 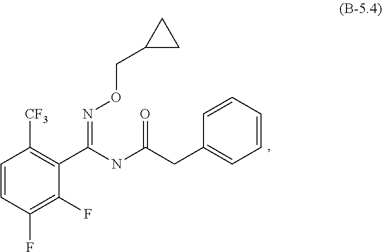
a compound of formula B-5.5 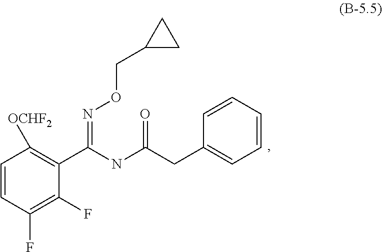
a compound of formula B-5.6 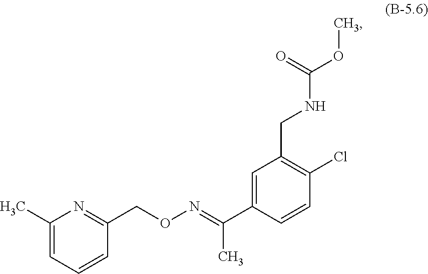
a compound of formula B-5.7 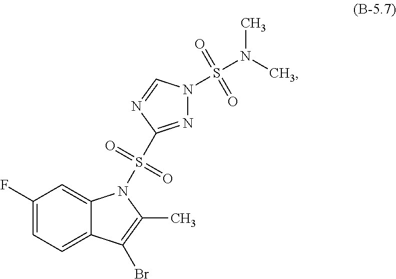
3-difluoromethyl-1-methyl-1H-pyrazole-4-carboxylic acid (2-bicyclopropyl-2-yl-phenyl)-amide, 3-difluoromethyl-1-methyl-1H-pyrazole-4-carboxylic acid (9-isopropyp-1,2,3,4-tetrahydro-1,4-methano-naphthalen-5-yl)-amide, 1,3-dimethyl-5-fluoro-1H-pyrazole-4-carboxylic acid [2-(1,3-dimethylbutyl)phenyl]-amide, 3-difluoromethyl-1-methyl-1H-pyrazole-4-carboxylic acid (3′,4′-dichloro-5-fluoro-1,1′-biphenyl-2-yl)-amide, N-{2-[3-chloro-5-(trifluoromethyl)pyridin-2-yl]ethyl}-2-(trifluoromethyl)benzamid, 3-difluoromethyl-1-methyl-1H-pyrazole-4-carboxylic acid N-[2-(1,1,2,2-tetrafluoroethoxy)phenyl]-amide, 3-difluoromethyl-1-methyl-1H-pyrazole-4-carboxylic acid N-[2-(1,1,2,3,3,3-hexafluoropropoxy)phenyl]-amide, 3-difluoromethyl-1-methyl-1H-pyrazole-4-carboxylic acid N-[2-(2-chloro-1,1,2-trifluoroethoxy)phenyl]-amide, 3-difluoromethyl-1-methyl-1H-pyrazole-4-carboxylic acid N-(4′-trifluoromethyl-biphen-2-yl)-amide, 3-difluoromethyl-1-methyl-1H-pyrazole-4-carboxylic acid N-(2′-trifluoromethyl-biphen-2-yl)-amide, 3-difluoromethyl-1-methyl-1H-pyrazole-4-carboxylic acid N-(2′-trifluoromethyl-biphen-2-yl)-amide,
a compound of formula B-5.19 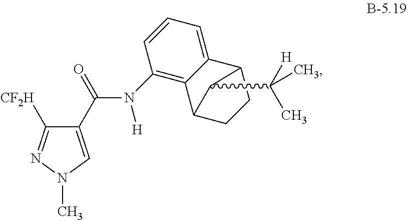
a compound of formula B-5.20 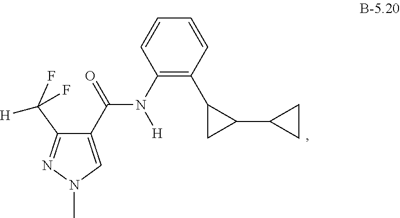
(B6) a plant-bioregulator selected from the group consisting of acibenzolar-5-methyl, chlormequat chloride, ethephon, mepiquat chloride and trinexapac-ethyl;
(B7) an insecticide selected from the group consisting of
abamectin, clothianidin, emamectin benzoate, imidacloprid, tefluthrin, thiamethoxam, lambda cyhalothrin,
a compound of formula B-7.1 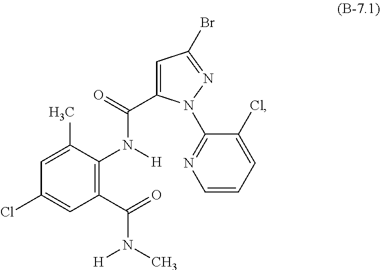
a compound of formula B-7.2; 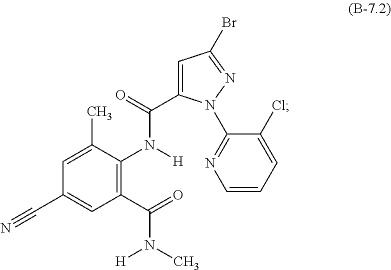
and
(B8) a herbicide selected from the group consisting of glyphosate, clodinafop propargyl and pinoxaden.

2. The composition according to claim 1, wherein component (A) is a compound of a compound of formula (I) 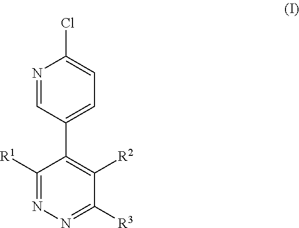
wherein
R¹ is methyl;
R² is 2,4,6-trifluorophenyl; and
R³ is chloro.

3. The composition according to claim 1, wherein component (A) is a compound of formula (I) 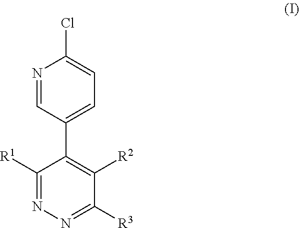
wherein
R¹ is methyl;
R² is 2-chloro-6-fluoro-phenyl; and
R³ is chloro.

4. The composition according to claim 1, wherein component (A) is a compound of formula (I) 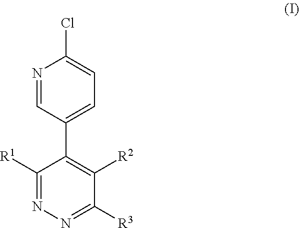
wherein
R¹ is methyl;
R² is 2,4,6-trifluorophenyl; and
R³ is methoxy.

5. The composition according to claim 1, wherein component (B) is selected from the group consisting of
(B1) a strobilurin fungicide selected from the group consisting of azoxystrobin and pyraclostrobin;
(B2) an azole fungicide selected from the group consisting of cyproconazole, difenoconazole, epoxiconazole, metconazole, penconazole, propiconazole, prothioconazole, tebuconazole;
(B3) a morpholine fungicide: fenpropidin;
(B4) an anilinopyrimidine fungicide: cyprodinil;
(B5) a fungicide selected from the group consisting of boscalid, chlorothalonil, fludioxonil, mancozeb,
a compound of formula B-5.19 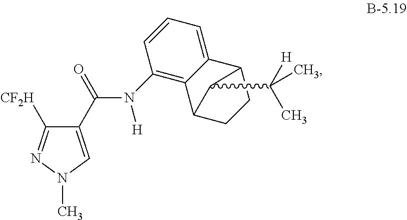
and a compound of formula B-5.20 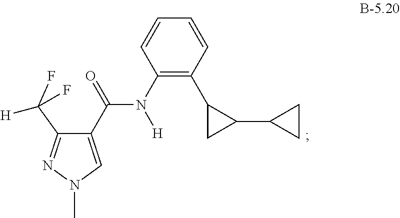
(B6) a plant-bioregulator selected from the group consisting of acibenzolar-5-methyl and trinexapac-ethyl;
(B7) an insecticide selected from the group consisting of thiamethoxam and lambda cyhalothrin; and
(B8) a herbicide selected from the group consisting of glyphosate, clodinafop propargyl and pinoxaden.

6. The composition according to claim 1, wherein component (B) is selected from the group consisting of
(B1) a strobilurin fungicide: azoxystrobin;
(B2) an azole fungicide selected from the group consisting of cyproconazole, difenoconazole, epoxiconazole, propiconazole, prothioconazole;
(B4) an anilino-pyrimidine fungicide: cyprodinil;
(B5) a fungicide selected from the group consisting of chlorothalonil, mancozeb and
a compound of formula B-5.19 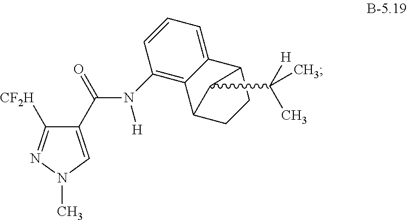
and
(B7) an insecticide: thiamethoxam.

7. The composition according to claim 1, wherein the weight ratio of (A) to (B) is from 2000:1 to 1:1000.

8. A method of controlling diseases on useful plants or on propagation material thereof caused by phytopathogens, which comprises applying to the useful plants, the locus thereof or propagation material thereof a composition according to claim 1.

9. The method according to claim 8, wherein the disease is a species of Alternaria spp. and the useful plants are potato or tomato.

10. The method according to claim 8, wherein the disease is a species of Mycosphaerella spp. and the useful plants are wheat or groundnut.

11. The method according to claim 8, wherein the disease is a species of Pyrenophora spp. and the useful plant is barley.
